(19) United States
(12) Patent Application Publication
(10) Pub. No.: US 2024/0021817 A1
(43) Pub. Date: Jan. 18, 2024

(54) PROCESS FOR TRANSFORMING SILICON SLAG INTO HIGH CAPACITY ANODE MATERIAL FOR LITHIUM-ION BATTERIES

(71) Applicant: HPQ SILICON INC., MONTREAL (CA)

(72) Inventors: Lionel ROUÉ, SAINTE-JULIE (CA); Victor VANPEENE, CHATOU (FR); Alexandre HEITZ, PEYRINS (FR); Ali SHAHVERDI, VERDUN (CA); Milad MARDAN, SAINT-LAURENT (CA); Pierre CARABIN, MONTRÉAL (CA)

(21) Appl. No.: 18/034,854

(22) PCT Filed: Nov. 1, 2021
(86) PCT No.: PCT/CA2021/000100

§ 371 Date: May 1, 2023

Related U.S. Application Data
(60) Provisional application No. 63/108,257, filed on Oct. 30, 2020.

(51) Int. Cl. H01M 4/58; C22B 7/04; H01M 4/04; H01M 4/66; H01M 10/0525

(52) U.S. Cl. CPC H01M 4/58; C22B 7/04; H01M 4/0404; H01M 4/0471; H01M 4/661; H01M 10/0525; H01M 2004/027

(57) ABSTRACT

A method for transforming silicon slag into an anode material in lithium-ion batteries, comprising applying mechanical grinding, such as high-energy ball milling, to reduce particle size of silicon slag to micron and submicron sizes and/or to increase the amorphicity of the silicon slag powder. The silicon slag being used as raw material in fabricating the anodes has a composition of Si—SiC—C—Si_{O}2, preferably having Si phase in both crystalline and amorphous states, and more preferably having Si phase only in amorphous state after a high-energy ball-milling thereof. The silicon slag has preferably a median particle diameter ≤20 μm after a high-energy ball-milling thereof and ≤2 μm after a slurry homogenization thereof. The silicon slag preferably contains 64% wt. Si+31% wt SiC+4% wt. C+1% wt. SiO₂.

### CROSS REFERENCE TO RELATED APPLICATIONS

This Application claims priority on U.S. Provisional Application No. 63/108,257, now pending, filed on Oct. 30, 2020, which is herein incorporated by reference.

### FIELD

The present subject matter relates to a method to transform a by-product of the carbothermic reduction of silica (SiO₂), labelled silicon slag, containing Si, SiC, C and SiO₂ materials, to a high-capacity anode material for lithium-ion batteries.

### BACKGROUND

With rapid development of electric vehicles, portable electronic devices and green energy production, the lithium-ion batteries (LiBs) technology is under extensive development towards a higher energy density along with a higher power density. Currently, commercialized LiBs adopt graphite as the anode material. However, developing a novel anode material with higher storage capacity than graphite is highly relevant for next generation LiBs. Moreover, graphite is mostly sourced from natural reserves by mining activities, which imposes significant pressure on natural resources. Additionally, the mined graphite is not suitable to be directly used in LiBs and requires to be further modified by multi-step processes which generate waste and additional costs. Consequently, there is an urge of providing cheaper, greener and higher capacity materials to replace graphite anode in LiBs.

According to extensive investigations in recent years [1], silicon could be a good alternative to graphite to be used as an active anode material in LiBs [1-3]. The main reason for attention towards silicon is its natural abundance (28 weight % in the earth crust), environmentally friendly and high capacity compared to graphite. Indeed, the theoretical specific capacity of silicon is about 10 times more than graphite (3579 mAh/g and 372 mAh/g for silicon and graphite, respectively) [4]. However, the physical and chemical properties of silicon limit its implementation in commercial Li-ion batteries. Silicon undergoes a large volume change (up to 280%) [4] upon lithiation/delithiation cycles, thereby resulting in degradation of the anode material and loss of contact between the anode material and the current collector which leads to loss of capacity upon cycling. Additionally, the instability of the solid electrolyte interphase (SEI) layer on the Si particles due to their huge volume change upon cycling results in moderate coulombic efficiency and in the growth of a blocking layer, which further inhibits lithium diffusion through the electrode, degrading the overall LiB performance.

Hence, the main challenge is to overcome the important volume change and resulting mechanical stress and strain created during cycling. One of the promising solutions is to use nanosized silicon particles. It has been shown [2, 3, 6-11] that by using smaller silicon particles, their pulverization can be reduced to a certain extent, which results in a better cyclability of the electrode. However, the use of nanoscale silicon particles solely is not the ultimate solution and has its limits. For instance, the aggregation of Si nanoparticles during cycling affects negatively the battery performance. Another solution is to use a nanosized silicon carbon composite material [12-17]. Carbon can improve the anode electrical conductivity. However, the big advantage of carbon is its mechanical buffering characteristic, mitigating internal stress and strain forces caused by Si volume change during full lithiation and enhancing the coulombic efficiency and cycling stability of the composite materials [18,19]. On the other hand, it has been shown [14, 20] that another form of silicon-carbon composite containing SiOₓ can increase the electrochemical performance of LIB anodes. Additionally, the use of amorphous Si (a-Si) instead of crystalline Si (c-Si) can be beneficial as a-Si provides more paths for the insertion/extraction of lithium and the volume expansion of a-Si upon lithiation is isotropic, which causes less pulverization compared with the highly anisotropic expansion of c-Si [21]. For instance, a-Si@SiOₓ/C composites with amorphous Si particles as core and coated with a double layer of SiOₓ and carbon were prepared by ball-milling crystal micron-sized silicon powders and carbonization of the citric acid intruded in the ball-milled Si. With an optimized Si to citric acid weight ratio of 1/2.5, corresponding to 8.4 wt. % C in the composite, a capacity of 1450 mA h g⁻¹ was obtained after 100 cycles at a current density of 100 mA g¹ compared to 650 mAh/g for the electrode prepared with pristine Si powder [22].

The electrochemical performance of nanostructured Si-based materials, including their cycling stability and coulombic efficiency, must be further improved to ensure their integration into the next generation of high energy density LiBs. Their low compactness, and their high surface reactivity are also major obstacles to their commercialization. Moreover, most of the known silicon-based nanocomposites production techniques are costly and involve complex multi-stage procedures, which are difficult to transfer to an industrial scale. There are also challenges involved in introducing these nanomaterials into electrode fabrication lines, especially as nanoparticles are known to possess inhalation and often explosion risks, and poor flow and delicate handling.

Silicon is mainly produced via carbothermic reduction of silica, for instance in the form of quartz. Quartz is abundant in the nature and it is present in high purity form. The silicon smelter producing silicon metal with purity exceeding 98% produces a waste stream called silicon slag. This silicon slag has no obvious commercial use and cannot be valorized, despite it containing a notable quantity of silicon and silicon carbide. Due to the intensive energy requirement in silicon smelting processes, silicon slag waste stream represents a considerable energy loss in addition to material loss. By valorizing this waste stream as energy storage material, a greener silicon production is offered.

It would therefore be desirable to provide a new method to transform silicon slag, a by-product of the carbothermic reduction of silica (SiO₂), to a high-capacity anode material for lithium-ion batteries.

### SUMMARY

It would thus be desirable to provide a novel method to transform silicon slag into a material for use in anodes for lithium-ion batteries.

The embodiments described herein provide in one aspect a method for transforming silicon slag into an anode material in lithium-ion batteries, comprising applying mechanical grinding, such as high-energy ball milling, to reduce particle size of silicon slag to micron and submicron sizes.

Also, the embodiments described herein provide in another aspect a method for transforming silicon slag into an anode material in lithium-ion batteries, comprising applying mechanical grinding, such as high-energy ball milling, to increase the amorphicity of the silicon slag powder.

Furthermore, the embodiments described herein provide in another aspect a method for fabricating an anode material for use in lithium-ion batteries, comprising: producing a silicon slag via a carbothermic reduction of silica at elevated temperatures, preferably above 1400° C.; submitting the silicon slag to mechanical grinding, such as high energy ball milling, for reducing particle size thereof to micron and sub-micron sizes and for increasing an amorphicity of the silicon slag.

Furthermore, the embodiments described herein provide in another aspect a silicon slag containing Si—C—O as the main elemental constituents, the silicon slag being used as raw material in fabricating anodes for use in lithium-ion batteries, wherein the silicon slag has a composition of Si—SiC—C—SiO₂.

Furthermore, the embodiments described herein provide in another aspect a silicon slag containing Si—C—O as the main elemental constituents, the silicon slag being used as raw material in fabricating anodes for use in lithium-ion batteries, wherein the silicon slag has a composition of Si—SiC—C—SiO₂, preferably having Si phase in both crystalline and amorphous states, and more preferably having Si phase only in amorphous state after a high-energy ball-milling thereof.

Furthermore, the embodiments described herein provide in another aspect a silicon slag containing Si—C—O as the main elemental constituents, the silicon slag being used as raw material in fabricating anodes for use in lithium-ion batteries, wherein the silicon slag has a composition of Si—SiC—C—SiO₂, preferably having a median particle diameter ≤20 μm after a high-energy ball-milling thereof and ≤2 μm after a slurry homogenization thereof.

Furthermore, the embodiments described herein provide in another aspect a silicon slag containing Si—C—O as the main elemental constituents, the silicon slag being used as raw material in fabricating anodes for use in lithium-ion batteries, wherein the silicon slag has a composition of Si—SiC—C—SiO₂, preferably containing 64% wt. Si+31% wt. SiC+4% wt. C+1% wt. SiO₂.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 is an exemplary schematic representation of the process steps for the fabrication of Si slag-based anodes for use in Li-ion batteries, in accordance with an exemplary embodiment;

FIG. 2 is an exemplary graph showing PSD curves of the Si slag powder at different steps of the process, in accordance with an exemplary embodiment;

FIG. 3 is an exemplary graph showing an XRD pattern of the Si slag powder before and after the high-energy ball-milling (HEBM) step, in accordance with an exemplary embodiment;

FIG. 4 are exemplary SEM and EDS images of the Si slag powder after the high-energy ball-milling (HEBM) step, in accordance with an exemplary embodiment;

FIG. 5 is an exemplary graph showing a discharge capacity as a function of the cycle number of a Si slag-based electrode compared to a graphite-based electrode, in accordance with an exemplary embodiment; and

FIG. 6 is an exemplary graph showing a capacity retention as a function of the areal mass loading of the Si slag-based electrode.

### DESCRIPTION OF VARIOUS EMBODIMENTS

The present subject matter uses the silicon slag produced by carbothermic reduction of silica, for example the silicon slag produced by carbothermic reduction of quartz under vacuum [23]. The present process transforms quartz (SiO₂) into silicon (Si) and eliminates impurities, offering the possibility of producing silicon ranging from metallurgical grades (purity+99%) to solar grades (purity+99.99%). The by-product of the vacuum carbothermic reduction process, labelled silicon slag, consists of a mixture of amorphous and crystalline silicon (a-Si and c-Si), silicon carbide (SiC), carbon (C) and silicon oxide (SiOₓ). This silicon slag is ball-milled in order to decrease its particle size and to increase its amorphicity. This low-cost material is used for the preparation of high-capacity LiB anodes exhibiting a specific capacity 3-4 times greater than that of a conventional graphite-based anode.

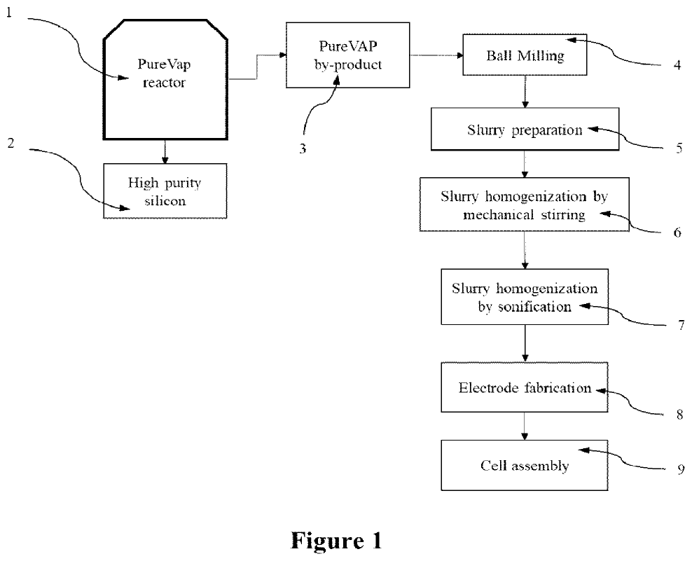

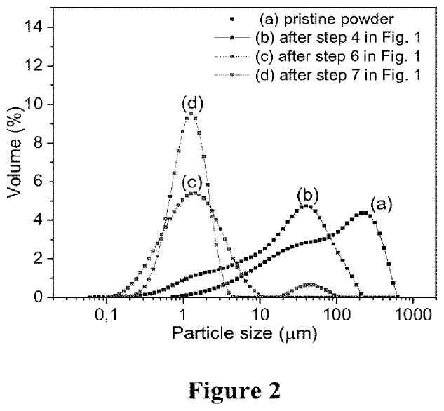

With regards to a Si slag production, reference is made to FIG. 1, which shows that silicon slag 3 is a by-product of the carbothermic reduction process of quartz effected in a reactor 1, which is described in U.S. Patent Application Publication No. US 2018/0237306 A1 [23]. The silicon slag 3 is herein further used as the raw material for anode fabrication and electrochemical performance testing as described hereinbelow. The main product of this carbothermic reduction process is high purity silicon referenced at 2 in FIG. 1. The composition of the pristine Si slag (the by-product of silicon production) after first ball milling, pulverization process is 64 wt. % Si+31% wt. SIC+4% wt. C+1% wt. SiO₂. The median diameter (Dᵥ₅₀) of the silicon slag particles after first ball milling is 70.5 μm. Its particle size distribution (PSD) curve, determined by laser scattering method, is shown in FIG. 2 (see curve (a)).

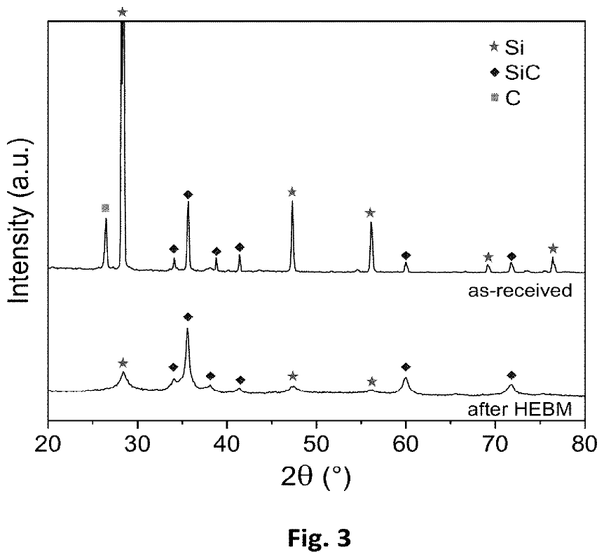

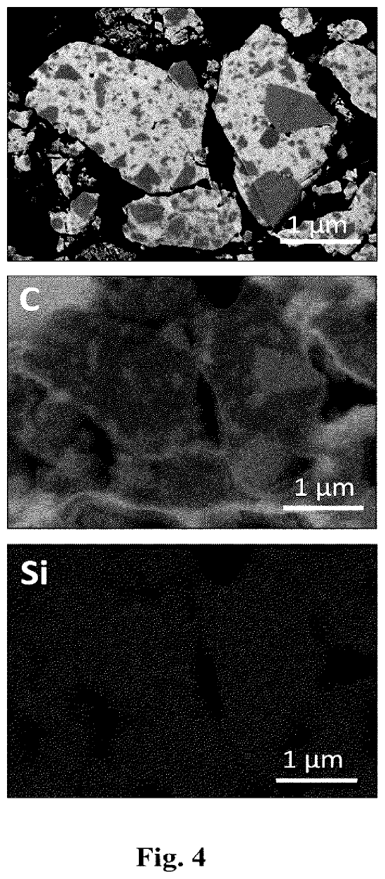

Now turning to a Si slag ball-milling step, which is identified by reference numeral 4 in FIG. 1, the slag ball-milling step is a two-step process in which the Si slag powder after first ball milling at low energy for a few minutes in air undergoes the second ball milling at high energy under inert atmosphere such argon for 20 h using a SPEX 8000 vibratory mixer with a ball-to-powder mass ratio of 5:1. The Si slag powder (4.5 g) is introduced along with three (3) stainless-steel balls (one of 14.3 mm in diameter, and two of 11.1 mm in diameter, with a total weight of 22.3 g) into a stainless-steel vial (50 ml). The obtained silicon slag powder consists of micrometric agglomerates with a median size ˜18.9 μm made of sub-micrometric particles more or less welded together. Its PSD curve is shown at curve (b) in FIG. 2. As highlighted by comparing the XRD pattern (see FIG. 3) of the Si slag powder before and after the high-energy ball-milling (HEBM) process 4, the latter induces significant change in the crystalline structure of the Si slag powder. Especially, after the ball-milling step 4, the Si phase in the Si slag is nearly fully amorphous as suggested from the important decrease of the intensity of the Si diffraction peaks in FIG. 3. Moreover, the C diffraction peak at 26.4° is no longer detected, suggesting that Si and C phases react together during HEBM to form a SiC phase. The complete reaction of C phase in the Si slag after 20 h of HEBM was confirmed from its thermogravimetric analysis performed under air where no mass loss related to the oxidation of free C was observed. Actually, as shown from BSE and EDS images (FIG. 4), most HEBM Si slag particles are constituted of SiC and Si materials, where submicrometric SiC particles (typically 10-500 nm in size) are embedded in a Si matrix.

Additionally, the O content in the ball-milled Si slag powder (measured with a LECO oxygen analyser) is 1.5 wt % compared to 0.5 wt % before ball-milling.

With respect to the subsequent slurry preparation and homogenization of steps 5 to 7 in FIG. 1, Graphene nanoplatelets (GnP) (M grade from XGSciences, average diameter=15 μm, average thickness=6-8 nm, surface area=120-150 m²/g according to the suppliers data) is used as a conductive additive. Carboxymethyl cellulose (CMC) (DS=0.7, Mw=90000 g/mol, Sigma-Aldrich) is used as a binder. Citric acid (99.5+ %, Alfa Aesar) and KOH salts (85+ %, Alfa Aesar) are used to prepare a pH3 buffer solution (0.17 M citric acid+0.07 M KOH) as a slurry medium. A slurry is prepared at step 5 of FIG. 1 by mixing 200 mg of powder (80% wt. ball-milled Si slag, 8% wt. CMC and 12% wt. GnP) in 0.5 mL of pH 3 buffer solution. Slurry homogenization, at step 6, is performed using a Fritsch Pulverisette 7 planetary mixer at 500 rpm for 1 h in presence of 3 silicon nitride balls (9.5 mm in diameter). During this slurry homogenization step 6, the Si slag agglomerates are broken and the median diameter of the Si slag particles is reduced to 1.3 μm. Its PSD curve is shown in FIG. 2 (see curve (c)). In order to break the residual agglomerates, an additional homogenization of the slurry can be performed, at step 7, by sonification for 30 min. The corresponding PSD curve is shown at curve (d) in FIG. 2, which confirms that the large agglomerates (diameter>˜10 μm) have been eliminated (broken).

The next step is the electrode preparation step 8 of FIG. 1. Once the slurry is homogenised (step 6 and possibly step 7), it is coated on a copper foil (25 μm thick) by using a doctor blade. After the coating step, the foil is dried at room temperature in air for 12 h. Electrodes of 1 mm diameter are then punched out of the so-obtained coated foil and subsequently dried at 100° C. under vacuum. Electrodes with an aerial mass loading of 1-2 mg of Si slag per cm² are selected for electrochemical analysis. The capacities are expressed in mAh per g of Si slag.

Step 9 of FIG. 1 is directed to assembling of the cell, wherein the electrodes of step 8 are mounted in two-electrode Swagelok ® cells in an argon-filled glove box. The working electrode, i.e. the Si slag-based electrode, is placed towards a lithium metal electrode (1 mm thick), acting as a counter and reference electrode. The electrodes are separated with a borosilicate glass-fiber (Whatman GF/D) membrane soaked with an electrolytic solution of 1 M LiPF₆ in ethylene carbonate (EC) and dimethyl carbonate (DMC) (1:1) with 10 wt. % fluoroethylene carbonate (FEC). An appropriate contact between the different components of the cell is ensured by a spring placed on the counter electrode side, which is slightly compressing the cell.

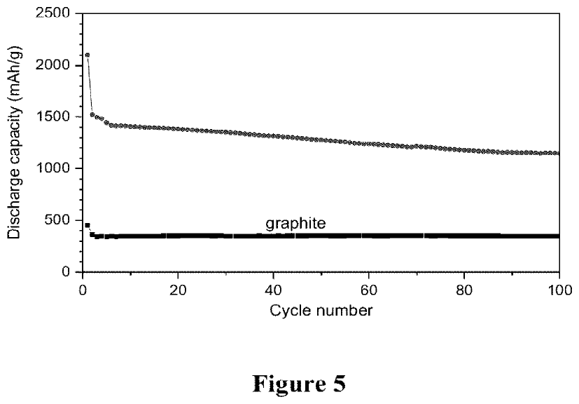

Regarding electrode performance, the Si slag electrodes are cycled on an Arbin BT2000 cycler at room temperature in galvanostatic mode at full capacity between 1 V and 5 mV vs. Li/Li⁺ at a current density of 180 mA/g of Si slag for the five first cycles and then at 400 mA/g of Si slag for the subsequent cycles. FIG. 5 shows the evolution with cycling of the discharge capacity of the Si-slag-based electrode (areal mass loading of 2 mg Si slag/cm²). The discharge capacity evolution of a graphite-based electrode (4.5 mg graphite/cm², composition of 94.5 wt. % graphite, 1 wt. % C65 carbon black, 2.5 wt. % CMC and 2.5 wt. % SBR) cycled at a current density of 15 mA/g of graphite for the first 2 cycles and at 190 mA/g for the subsequent cycles is also shown for comparison. The initial discharge capacity of the Si slag-based electrode is 2100 mAh/g compared to 460 mAh/g for the graphite-based electrode made from commercial battery-grade graphite (PGPT102 from Targray). Their initial coulombic efficiency is about 70 and 78%, respectively. After 100 cycles, the discharge capacity of the Si slag-based electrode is 1150 mAh/g compared to 350 mAh/g for the graphite-based electrode with a mean coulombic efficiency of 99.9% and 99.3%, respectively.

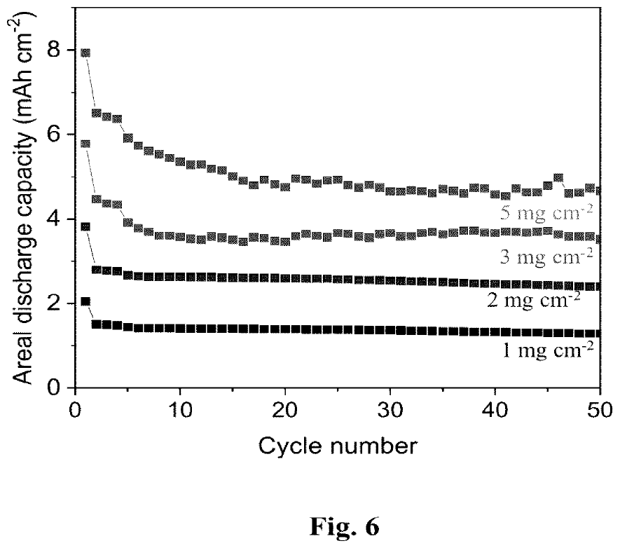

FIG. 6 compares the cycling performance of the Si slag electrode depending on its areal mass loading (from 1 to 5 mg Si slag cm⁻²). As expected, a lower capacity retention is observed as the areal mass loading of the electrode increases because an increase of the electrode mass loading (thickness) means an increase of the mechanical strain associated with the Si volume change within the coating and at the interface with the current collector. However, one can note that the Si slag electrode is able to maintain a rather stable capacity over cycling for a mass loading as high as 3 mg cm⁻², corresponding to a practical relevant areal capacity of about 3.5 mAh cm⁻² after 50 cycles at a current density of 1.2 mA cm⁻².

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

[1] C. Sun, ed., “Advanced Battery Materials”, Wiley, 2019.
[2] M. N. Obrovac, V. L. Chevrier, Alloy Negative Electrodes for Li-Ion Batteries, Chem. Rev., 114 (2014) 11444-11502.
[3] U. Kasavajjula, C. Wang, A. J. Appleby, “Nano- and bulk-silicon-based insertion anodes for lithium-ion secondary cells”, Journal of Power Sources. 163 (2007) 1003-1039. https://doi.org/10.1016/j.jpowsour.2006.09.084.
[4] M. N. Obrovac, L. J. Krause, Reversible cycling of crystalline silicon powder, J. Electrochem. Soc. 154 (2007) A103-A108.
[5] X. H. Liu, H. Zheng, L. Zhong, S. Huang, K. Karki, L. Q. Zhang, Y. Liu, A. Kushima, W. T. Liang, J. W. Wang, J.-H. Cho, E. Epstein, S. A. Dayeh, S. T. Picraux, T. Zhu, J. Li, J. P. Sullivan, J. Cumings, C. Wang, S. X. Mao, Z. Z. Ye, S. Zhang, J. Y. Huang, “Anisotropic swelling and fracture of silicon nanowires during lithiation”, Nano Lett. 11 (2011) 3312-3318. https://doi.org/10.1021/nl201684d.
[6] H. Wu, Y. Cui, “Designing nanostructured Si anodes for high energy lithium ion batteries”, Nano Today. 7 (2012) 414-429. https://doi.org/10.1016/j.nantod.2012.08.004.
[7] J. R. Szczech, S. Jin, “Nanostructured silicon for high capacity lithium battery anodes”, Energy Environ. Sci. 4 (2010) 56-72. https://doi.org/10.1039/C0EE00281J.
[8] D. Wang, M. Gao, H. Pan, J. Wang, Y. Liu, “High performance amorphous-Si@SiOx/C composite anode materials for Li-ion batteries derived from ball-milling and in situ carbonization”, Journal of Power Sources. 256 (2014) 190-199. https://doi.org/10.1016/j.jpowsour.2013.12.128.
[9] X. H. Liu, L. Zhong, S. Huang, S. X. Mao, T. Zhu, J. Y. Huang, “Size-Dependent Fracture of Silicon Nanoparticles During Lithiation”, ACS Nano. 6 (2012) 1522-1531. https://doi.org/10.1021/nn204476h.
[10] M. T. McDowell, I. Ryu, S. W. Lee, C. Wang, W. D. Nix, Y. Cui, “Studying the Kinetics of Crystalline Silicon Nanoparticle Lithiation with In Situ Transmission Electron Microscopy”, Advanced Materials. 24 (2012) 6034-6041. https://doi.org/10. 1002/adma.201202744.
[11] I. Ryu, J. W. Choi, Y. Cui, W. D. Nix, “Size-dependent fracture of Si nanowire battery anodes”, Journal of the Mechanics and Physics of Solids. 59 (2011) 1717-1730. https://doi.org/10.1016/j.jmps.2011.06.003.
[12] X. Su, Q. Wu, J. Li, X. Xiao, A. Lott, W. Lu, B. W. Sheldon, J. Wu, “Silicon-Based Nanomaterials for Lithium-Ion Batteries: A Review, Advanced Energy Materials”. 4 (2014) 1300882. https://doi.org/10.1002/aenm.201300882.
[13] Y. Fan, Q. Zhang, Q. Xiao, X. Wang, K. Huang, “High performance lithium ion battery anodes based on carbon nanotube—silicon core—shell nanowires with controlled morphology”, Carbon. 59 (2013) 264-269. https://doi.org/10.1016/j.carbon.2013.03.017.
[14] P. Li, G. Zhao, X. Zheng, X. Xu, C. Yao, W. Sun, S. X. Dou, “Recent progress on silicon-based anode materials for practical lithium-ion battery applications”, Energy Storage Materials. 15 (2018) 422-446. https://doi.org/10.1016/j.ensm.2018.07.014.
[15] Y. Liu, K. Hanai, J. Yang, N. Imanishi, A. Hirano, Y. Takeda, “Silicon/Carbon Composites as Anode Materials for Li-Ion Batteries”, Electrochem. Solid-State Lett. 7 (2004) A369-A372. https://doi.org/10.1149/1.1795031.
[16] J. Lyubina, “Silicon-carbon composite powder”, U.S. Patent Application Publication No. US 201910016601 A1, 2019. https://patents.google.com/patent/US20190016601A1/en?oq=Silicon -carbon+composite+powder+2019%2f0016601.
[17] X. Ma, M. Liu, L. Gan, P. K. Tripathi, Y. Zhao, D. Zhu, Z. Xu, L. Chen, “Novel mesoporous Si@C microspheres as anodes for lithium-ion batteries”, Phys. Chem. Chem. Phys. 16 (2014) 4135-4142. https://doi.org/10.1039/C3CP54507E.
[18] M. N. Obrovac, V. L. Chevrier, “Alloy Negative Electrodes for Li-Ion Batteries”, Chem. Rev. 114 (2014) 11444-11502. https://doi.org/10.1021/cr500207g.
[19] S. Chae, N. Kim, J. Ma, J. Cho, M. Ko, “One-to-One Comparison of Graphite-Blended Negative Electrodes Using Silicon Nanolayer-Embedded Graphite versus Commercial Benchmarking Materials for High-Energy Lithium-Ion Batteries”, Advanced Energy Materials. 7 (2017) 1700071. https://doi.org/10.1002/aenm.201700071.
[20] J. Zhang, J. Gu, H. He, M. Li, “High-capacity nano-Si@SiOx@C anode composites for lithium-ion batteries with good cyclic stability”, J Solid State Electrochem. 21 (2017) 2259-2267. https://doi.org/10.1007/s10008-017-3578-3.
[21] M. T. McDowell, S. W. Lee, J. T. Harris, B. A. Korgel, C. Wang, W. D. Nix, Y. Cui, “In Situ TEM of Two-Phase Lithiation of Amorphous Silicon Nanospheres”, Nano Lett. 13 (2013) 758-764.
[22] D. Wang, M. Gao, H. Pan, J. Wang, Y. Liu, “High performance amorphous-Si@SiOx/C composite anode materials for Li-ion batteries derived from ball-milling and in situ carbonization”, J. Power Sources 256 (2014) 190-199.
[23] A. Shahverdi, P. Carabin, “Silica to high purity silicon production process”, U.S. Patent Application Publication No. US 2018/0237306 A1, 2018. https://patents.google.com/patent/US20180237306A1/en.

1. A method for fabricating an anode material for use in lithium-ion batteries, comprising: producing a silicon slag via a carbothermic reduction of silica at elevated temperatures, preferably above 1400° C.; and submitting the silicon slag to mechanical grinding.

2. The method as defined in claim 1, wherein the mechanical grinding is effected using high energy ball milling, for reducing particle size thereof to micron and sub-micron sizes.

3. The method as defined in any one of claims 1 to 2, wherein the mechanical grinding is effected using high energy ball milling, for increasing an amorphicity of the silicon slag.

4. The method as defined in any one of claims 1 to 3, wherein the mechanical grinding is applied to produce a powder mainly constituted of SIC and Si materials, where submicrometric SiC particles are embedded in a Si matrix.

5. The method as defined in any one of claims 1 to 4, wherein the composition of the pristine Si slag after the mechanical grinding, for instance via ball milling, is 64 wt. % Si+31% wt. SiC+4% wt. C+1% wt. SiO₂.

6. The method as defined in any one of claims 1 to 5, wherein the slag mechanical grinding step is effected via ball milling, and wherein the slag ball-milling step is a two-step process in which the Si slag powder after a first ball milling at low energy for a few minutes in air undergoes a second ball milling at high energy under inert atmosphere, such as argon.

7. The method as defined in any one of claims 1 to 6, wherein the mechanical grinding step is followed by a slurry preparation step, for instance by mixing 200 mg of powder (80% wt. ball-milled Si slag, 8% wt. CMC and 12% wt. GnP) in 0.5 mL of pH 3 buffer solution.

8. The method as defined in claim 7, wherein the slurry preparation step is followed by a slurry homogenization step, for instance performed using a Fritsch Pulverisette planetary mixer at 500 rpm for 1 h in presence of 3 silicon nitride balls (9.5 mm in diameter).

9. The method as defined in claim 8, wherein during the slurry homogenization step, the Si slag agglomerates are broken and the median diameter of the Si slag particles is reduced to 1.3 μm.

10. The method as defined in any one of claims 8 to 9, wherein an additional homogenization of the slurry is performed by sonification, for instance for 30 min, in order to break the residual agglomerates.

11. The method as defined in any one of claims 8 to 10, wherein the slurry homogenization step is followed by an electrode preparation step, wherein the homogenised slurry is coated on a copper foil, for instance 25 μm thick, by using for instance a doctor blade.

12. The method as defined in claim 11, wherein after the homogenised slurry has been coated, the foil is dried at room temperature in air, for instance for about 12 h.

13. The method as defined in any one of claims 11 to 12, wherein electrodes, of for instance 1 mm in diameter, are then punched out of the so-obtained coated foil and subsequently dried, for instance at 100′C, typically under vacuum.

14. The method as defined in any one of claims 11 to 13, wherein after the electrode preparation step, a cell is assembled, wherein the electrodes are mounted in two-electrode Swagelok® cells in an argon-filled glove box, a working electrode, i.e. the Si slag-based electrode, being placed towards a lithium metal electrode, for instance 1 mm thick, acting as a counter and reference electrode; wherein the electrodes are then typically separated with a borosilicate glass-fiber (Whatman GF/D) membrane soaked with an electrolytic solution, for instance of 1 M LiPF6 in ethylene carbonate (EC) and dimethyl carbonate (DMC) (1:1) with 10 wt. % fluoroethylene carbonate (FEC); and wherein an appropriate contact between the different components of the cell is ensured for instance by a spring placed on the counter electrode side, which is slightly compressing the cell.

15. A method for transforming silicon slag into an anode material in lithium-ion batteries, comprising applying mechanical grinding, such as high-energy ball milling, to reduce particle size of silicon slag to micron and submicron sizes.

16. A method for transforming silicon slag into an anode material in lithium-ion batteries, comprising applying mechanical grinding, such as high-energy ball milling, to increase the amorphicity of the silicon slag powder.

17. A method for transforming silicon slag into an anode material in lithium-ion batteries, comprising applying mechanical grinding, such as high-energy ball milling, to produce a powder mainly constituted of SiC and Si materials, where submicrometric SiC particles are embedded in a Si matrix.

18. A method for fabricating an anode material for use in lithium-ion batteries, comprising: producing a silicon slag via a carbothermic reduction of silica at elevated temperatures, preferably above 1400° C.; submitting the silicon slag to mechanical grinding, such as high energy ball milling, for reducing particle size thereof to micron and sub-micron sizes and for increasing an amorphicity of the silicon slag.

19. A silicon slag containing Si—C—O as the main elemental constituents, the silicon slag being used as raw material in fabricating anodes for use in lithium-ion batteries, wherein the silicon slag has a composition of Si—SiC—C—SiO₂.

20. A silicon slag containing Si—C—O as the main elemental constituents, the silicon slag being used as raw material in fabricating anodes for use in lithium-ion batteries, wherein the silicon slag has a composition of Si—SiC—C—SiO₂, preferably having Si phase in both crystalline and amorphous states, and more preferably having Si phase only in amorphous state after a high-energy ball-milling thereof.

21. A silicon slag containing Si—C—O as the main elemental constituents, the silicon slag being used as raw material in fabricating anodes for use in lithium-ion batteries, wherein the silicon slag has a composition of Si—SiC—C—SiO₂, preferably having a median particle diameter ≤20 μm after a high-energy ball-milling thereof and vim after a slurry homogenization thereof.

22. A silicon slag containing Si—C—O as the main elemental constituents, the silicon slag being used as raw material in fabricating anodes for use in lithium-ion batteries, wherein the silicon slag has a composition of Si—SiC—C—SiO₂, preferably containing 64% wt. Si+31% wt. SiC+4% wt. C+1% wt. SiO₂.
